(19) United States
(12) Patent Application Publication
(10) Pub. No.: US 2012/0217796 A1
(43) Pub. Date: Aug. 30, 2012

(54) Control Device for Putting An Electronic Member of a Communication Network on Hold Prior to Rebooting

(75) Inventor: Nicolas Morand, Antony (FR)

(73) Assignee: PEUGEOT CITROEN AUTOMOBILES SA, Velizy Villacoublay (FR)

(21) Appl. No.: 13/497,958

(22) PCT Filed: Sep. 22, 2010
(86) PCT No.: PCT/FR2010/051985

§ 371 Date: Apr. 25, 2012

(30) Foreign Application Priority Data
Sep. 23, 2009 (FR) 0956534

(51) Int. Cl. H02J 9/00; B60L 1/00

(52) U.S. Cl. 307/9.1; 307/64

(57) ABSTRACT

The invention relates to a control device (D) intended for forming part of an electronic member (OE) to be connected to a communication network (R) and which includes: i) a power-supply means (CV), intended for being supplied with power from an electric DI power source (BA); ii) a control means (MC) supplied with power from the power-supply means (CV) and providing at least the management of a communication protocol of the network (R); iii) an interface means (IN) between the control means (MC) and the network (R), supplied with power from the power-supply means (CV); iv) an auxiliary power supply means (MA) in charge of supplying the control means (MC) with an auxiliary power higher than a first threshold selected during a period predefined following an operating prohibition of said power-supply means (CV) requested by a stop signal when the voltage of the power-supply mains (BA) or the voltage supplied from the power-supply means (CV) is lower than a second selected threshold; and v) a management means (MG) connected to the output (SI) of the interface means (IN) and, in the event of receiving a stop signal, in charge of performing Figure unique at least one holding action during the predefined period with a view to rebooting at least one portion of the electronic member (OE) under adequate conditions.

### CROSS-REFERENCE TO RELATED APPLICATIONS

This application is the US National Stage, under 35 U.S.C. 371, of International App. No. PCT/FR2010/051985, which was filed on Sep. 22, 2010 and claims priority to French Application No. 0956534, which was filed on Sep. 23, 2009, and which is incorporated herein by reference.

### STATEMENT REGARDING FEDERALLY SPONSORED RESEARCH

Not Applicable.

### BACKGROUND

The invention relates to the operation of an electronic communicating device for a communication network, which is connected to an electrical power supply network, including, but not limited to, an on-board network of an automobile.

As known by those skilled in the art, some communication networks have a bus with electronic communication devices that are connected in parallel. Data exchange between the electronic communication devices occurs via the bus, such as with multiplexed frames. For example, this is the embodiment with networks such as CAN LS (“Controller Area Network Low Speed”), CAN HS (“Controller Area Network High Speed”), VAN (“Vehicle Area Network”), or LN (“Local Interconnect Network”). These types of networks are used in many areas, and in particular, in the area of automobiles.

The electronic communication devices in such networks are generally connected to an electrical power supply network having a voltage and current generator, such as an alternator, and an electrical energy storage module, such as a battery. For example, this is the embodiment for an on-board network of an automobile.

In some circumstances, such as during the start or restart phase of the engine of an automobile, a sometimes significant power drop can occur in the electrical supply network, due to the strong demand for current. This drop can damage the operation of some electronic devices which are connected to the network, such as processors, and can totally or partially degrade some performances ensured by the operations they totally or partially control, or even prevent the execution of some safety operations. Furthermore, if the supply voltage of an electronic device drops below a designated threshold, a sudden stop of its operation in some logic states may occur, thereby, harming the operation or performance to be provided when restarted. This is especially true if at the time of the stop it was in a sending or receiving communication phase with the network.

An occasional drop can be relatively acceptable, but frequent voltage drops can be very inconvenient. This can happen when driving the vehicle in urban areas or in a traffic jam when a vehicle is equipped with a so-called “start and stop” device. Such a device automatically stops the operation of the engine, such as an internal combustion engine, when the speed falls below a threshold and restarts the engine when the driver releases the brake pedal or steps on the accelerator pedal.

To at least partially remedy these voltage drops, a voltage regulated supply device is installed in series with the electrical supply network, between an electrical source and the electronic devices. This type of device provides effective regulation of the voltage supplied to the electronic devices located downstream, but fails to supply the current necessary for their operation. To address this, a larger sized device of this type must be used that is capable of supplying more current. Alternatively, several of these voltage regulated devices can be used, which are costly and require more space. Furthermore, such voltage regulated supply devices are relatively complex and only partially compensate for some voltage drops.

Therefore, the present invention limits at least some consequences which can be induced by some voltage drops when the operation is restarted, in particular in the presence of a small number of voltage regulated supply devices, or even in the presence of none.

To this end, the present invention is part of an electronic device which is connected to a communication network and includes:
a voltage supply device, receiving a voltage supply from an electrical supply source,
a control device receiving a voltage supply from the voltage supply device and managing at least a network communication protocol, and
an interface device between the control device and the communication network, receiving a voltage supply from the voltage supply device.

This device includes:
an auxiliary supply device which is configured or designed to provide an auxiliary voltage to the control device, which is higher than a first selected threshold during a predefined time after an exclusion of the operation of the voltage supply device requested by a stop signal when the voltage of the electrical supply network, or the voltage supplied by the voltage supply device is lower than a second selected threshold, and
a control device configured or designed, in an embodiment of reception of a stop signal, to execute during the predefined time at least one suspend action in view of rebooting under good conditions at least a part of the electronic device, and eventually, at least one operation controlled by it.

The device according to the present invention includes other characteristics which can be implemented separately or in combination, and in particular:
each suspend action for rebooting can be selected among at least the generation of a command intended to stop the operation of the interface device, the generation of a command intended to stop the operation of at least one external electrical device controlled by the control device in operation of eventual constraints, in particular in the safety domain, the generation of a command intended to store information, the generation of a command intended to generate protocol commands intended to improve the restart of a communication in progress with the network, the generation of a command intended to generate a signal warning the network of the temporary stop of the operation of the electronic device, the generation of a command intended to reduce the electrical consumption of the control device in operation of their type, the generation of a command intended to reduce the electrical consumption of at least one electrical device controlled by the control device, and the generation of a command intended to stop the operation of the control device in such manner as to cause a shutdown of the operation of the electronic device;
the interface device can be configured to send the stop signal to an output when the voltage of the electrical supply network is lower than a second selected threshold or when the voltage supplied by the voltage supply device is lower than a second selected threshold. In this embodiment, the control device connects to the output of the interface device to receive the stop signals;
the auxiliary supply device can be inserted between an output of the voltage supply device and an input of the control device and can be configured to form a reserve of electrical energy starting from the electrical energy which is supplied by the voltage supply device when the voltage supplied by the latter is greater than a third selected threshold;
the auxiliary supply device can have a capacitor suitable to discharge and deliver a decreasing auxiliary voltage greater than the second selected threshold during at least the predefined time;
the capacitor can be a polarized type;
it can have pull-up device to draw a voltage value, such as zero, installed in the electrical connection which connects the output of the interface device to the control device and is configured to support a high impedance during the operational stop of the voltage supply device;
the management device can be installed in the control device.

The present invention is also an electronic device connected to a communication network and having:
a voltage supply device configured to receive a voltage supply from an electrical supply source,
a control device configured to receive a voltage supply from the voltage supply device and manage at least a network communication protocol,
an interface device operatively connected between the control device and the communication network, and configured to receive a voltage supply from the voltage supply device, and
a control device as described above.

The electronic device according to the present invention can include other characteristics which can be implemented separately or in combination, and in particular:
the voltage supply device can be a DC/DC conversion type device connected to an external electrical supply source;
the interface device can be an emitter receiver line (or ERL);
the control device is a microprocessor.

The present invention is particularly suited for, but not limited to, communication networks installed in automobiles.

Other characteristics and advantages of the invention will become clear by examining the following detailed description, and the attached drawings, in which the unique figure illustrates schematically and operationally an electronic device connected to the bus of a communication network and including an implementation example of a control device according to the invention. The attached drawing serves not only to complete the invention, but contributes also to its definition, where needed.

### DESCRIPTION OF THE DRAWINGS

In the accompanying drawings which form part of the specification:

FIG. 1 is a schematic of a control device of in communication with a vehicle;

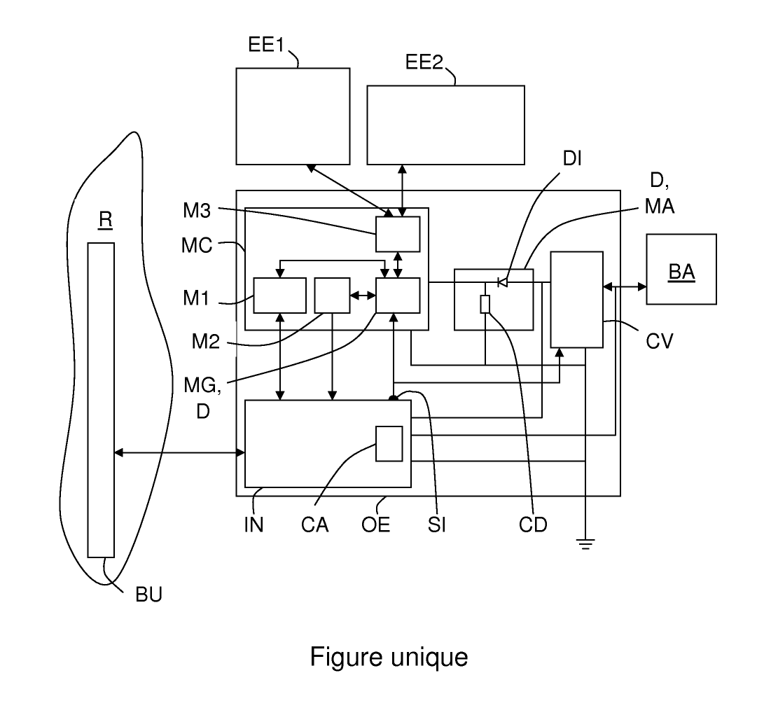

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

The present invention includes a control device D associated with a communicating electronic device OE connected in bypass via a bus BU to a communication network R.

In the specification, in the non-limiting embodiment, the communication network R is preferably a CAN LS type network (“Controller Area network Low Speed”). However, the present invention is not limited to this type of communication network, and can include any type of communication network equipped with a bus, and in particular, networks of the type CAN HS (“Controller Area Network High Speed”), VAN (“Vehicle Area Network”), and LIN (“Local Interconnect Network”).

In addition, in the non-limiting embodiment, the network R is part of a vehicle, such as an automobile. However, the present invention is not limited to this application, and, is also related to ground vehicles, ships and airplanes, as well as industrial installations having at least one communication network R.

In addition, in the illustrated non-limiting embodiment, the communicating electronic device OE is a processor with two connected electrical devices EEj (j=1 or 2), such as actuators. However, the present invention is not limited to this type of electronic device, and relates to any type of electronic device which is part of a communication network and needs a minimal voltage to work effectively or perform its operations.

As illustrated schematically and operationally in the figure, a communicating electronic device OE, such as a processor, has at least a voltage supply device CV, a control device MC, an interface device IN, and a control device D.

The voltage supply device CV is, for example, a DC/DC type converter (continuous/continuous) connected to an external electrical supply source BA. In the non-limiting illustrated embodiment, the external electrical supply source BA is an electrical supply network of the type of an on-board electrical network of an automobile. In this embodiment, the voltage supply device CV receives an input voltage from the on-board network B, between a voltage input and a ground, and generates a continuous voltage Vcc, which delivers between an output and a ground.

The on-board electrical network generally includes a voltage and a current generator, such as an alternator, a module for storage of electrical energy, such as a battery, and electrical links connecting with at least the electronic devices OE.

The control device MC receives a voltage supply from the voltage supply device CV. It can only operate correctly with a supply of minimal voltage. Its purpose is to manage or control at least one external piece of equipment or operation, and in particular, manage the communication protocol for network R via interface device IN.

In the illustrated non-limiting embodiment, the control device MC is configured as a microprocessor having a first module M1 for management of the communication protocol of the network R via the interface device IN, and, therefore all emission and reception communications, for example, by use of data reception signals and data emission signals, a second module M2 for management of the starting and stopping of the interface device IN by means of a two state command signal (start/stop), which can be delivered by device of several wires, and a third module M3 controlling two electrical devices EE1 and EE2, such as actuators.

On one hand, the control device MC can be configured as something other than a microprocessor, and on the other hand, to not include third module M3 when the electronic device OE is not managing external electrical devices.

The interface device IN receives voltage Vcc from the voltage supply device CV. They are configured or designed for securement of the interface between the logic circuits of their electronic device OE, and in particular of its control device MC, and the communication network R. To do this, and as illustrated in non-limiting manner in the unique figure, the interface device IN includes, for example, an input/output dedicated to exchanges with the first communication module M1 of the control device MC, another input/output dedicated to exchange of messages with the network R, and an input dedicated to the reception of the command signal delivered by the second communication module M2 of the control device MC.

In the illustrated non-limiting example, the interface device IN is configured in the form of an emitter receiver line (or ERL), but, this is not required.

The control device D according to the present invention includes an auxiliary supply device MA and control device MG.

The auxiliary supply device MA supplies an auxiliary voltage to the control device MC which is greater than a first selected threshold during a predefined time, following an exclusion of the operation of the voltage supply device CV requested by a stop signal when the voltage of the electrical supply network BA or the voltage supplied by the voltage supply device CV is lower than a second selected threshold.

It is understood that the objective here is to continue to supply energy to the control device MC during the predefined time, following the detection of a significant voltage drop in the on-board network BA, and therefore following the generation of a stop signal, so that after the voltage supply device CV stops operation, they have sufficient time to perform useful actions during the next operation start of the electronic device OE, following the end of this voltage drop across the on-board network BA.

The predefined time can be, for example, between approximately 10 μs and approximately 1 ms.

The value of the first threshold is typically selected as an function of the supply voltage Vcc of the control device MC, which is about 5V or 3.3V. Furthermore, it is selected so that the minimum auxiliary voltage at the end of the predefined time is sufficient regardless of the operating conditions of the electronic device OE and, in particular, regardless of the ambient temperature.

In the illustrated non-limiting embodiment, the auxiliary supply device MA is inserted between the output voltage Vcc of the voltage supply device CV and the input voltage of the control device MC. This embodiment creates a reserve of electrical energy starting from the electrical energy which is supplied by the voltage supply device CV, when the voltage Vcc that they deliver is greater than a third selected threshold.

As illustrated in this non-limiting embodiment, the auxiliary supply device MA includes a capacitor CD mounted in bypass so that the voltage Vcc at its terminals is in charge phase (or when constituting the reserve of electrical energy) and suitable for discharging and delivering an auxiliary voltage which is decreasing and greater than the second selected threshold during at least the predefined time.

The capacitor CD can be a polarized type, in particular, when it must have a high capacity, but, this is not required.

Also, as illustrated, the auxiliary supply device MA includes a diode DI mounted in series downstream of the supply output of the voltage supply device CV and upstream of one of the two terminals of the capacitor CD, so that the current flow from the voltage supply device CV circulates towards the control device MC, and the current flow from the capacitor CD is forced to circulate towards the control device MC to supply them, and not towards the voltage supply device CV.

In the illustrated non-limiting embodiment, the auxiliary supply device MA is external to the control device MC and to the voltage supply device CV, but this is not required. In fact, they can be installed in the control device MC or in the voltage supply device CV.

In the illustrated non-limiting embodiment, the auxiliary supply device MA connects to the supply output of the voltage supply device CV and to the supply input of the control device MC, but this is not required. In fact, they can be independent of the voltage supply device CV and/or connected to a dedicated auxiliary input of the control device MC.

Similarly, other functional groupings can be created inside the same physical sub-assembly. For example, one can envision incorporating at least one part of the voltage supply device CV in the interface device IN.

To be noted, the stop signal can be determined by an analog comparison circuit CA charged by comparing the voltage of the electrical supply network BA or the voltage supplied by the voltage supply device CV with the second threshold, possibly with a weak hysteresis.

As illustrated in a non-limiting embodiment, this analog comparison circuit CA can, for example, be incorporated in the interface device IN.

Alternatively, the stop signal can be delivered by a status machine integrated in the interface device IN, and take into account the status of network R.

In another embodiment, the stop signal can be delivered by the network R to the interface device IN or to the interface device IN and to the control device MC, in the form of information signaling the imminent voltage drop of the supply network BA.

In the illustrated non-limiting embodiment, the interface device IN includes comparison device CA configured for comparison to a second selected threshold the value of the voltage which is supplied by the supply network BA, in order to deliver to an output S1 a stop signal to stop the operation of the voltage supply device CV when the voltage is lower than the second selected threshold, possibly with a weak hysteresis.

To be noted, an embodiment not shown, the comparison device CA can be configured for comparison to the second selected threshold the value of the voltage which is supplied by the voltage supply device CV.

The second threshold is, for example, selected as an operation of the voltage which is normally supplied by the supply network BA, and in particular by its battery, when one is included, which is about 12V.

In the illustrated non-limiting embodiment, the output S1 of the interface device IN connects to an input of the voltage supply device CV and to an input of the control device MG to communicate the stop signal to each of them.

In this way, the control device MG is notified of the imminent operation stop of the voltage supply device CV. Regardless of its origin, the reception of the stop signal has for the control device MG has a trigger of suspend actions for rebooting which they will have to execute during the predefined time to facilitate a restart in good conditions for at least part of the electronic device OE.

To be noted, the actions for execution can be either predefined or programmed, or determined in real time by the control device MG in operation of their actual situation.

Any type of action useful for rebooting the electronic device OE can be envisioned.

An action of putting on hold can include generating a command to cause the generation of a signal ordering the stop of the operation of the interface device IN. This action can include, for example, sending a command message to the second module M2, ordering it to send the interface device IN a command signal where the status requests an immediate stop of the operation, before the voltage Vcc is no longer delivered to avoid the interface device IN applying erratic voltages to the network R.

Another suspend action can include generating a command to cause the generation of a signal ordering the stop of the operation of at least one external electrical device EEj controlled by the third module M3 of the control device MC, in operation of eventual constraints in particular in the safety domain. This action can include, for example, sending a command message to the third module M3 and ordering it to send to at least one of the electrical devices EEj which it controls a command signal of which the status requests the immediate stop of the operation. For example, it can stop the motor of a window actuator during the voltage drop of the on-board supply network, to reduce the consumption of current and therefore reduce the amplitude and duration of this drop, without significant effect for the client or device if the latter is in reboot phase and the drop is of short duration, whereby these two conditions are generally fulfilled.

Another suspend action can include generating a command to cause the storage, at least locally, of information, for example, defining the status of the electronic device OE and more precisely its modules M1 to M3 before it is no longer supplied with voltage.

Another suspend action can include generating a command to cause the generation of one or several protocol commands for restarting a communication in progress with the network R. This action can, for example, include sending a command message to the first communication module M1 ordering it to send to network R, via the interface device IN, protocol messages and/or to undertake local actions which will be useful for reestablishing the right communication after the end of the voltage drop. It can, for example, involve messages to the attention of other devices OE to be on standby or memorizing the type of message circulating on the network R at the moment of the voltage drop.

Another suspend action can include generating a command to cause the generation of a signal to warn the network of the temporary stop of the operation of the electronic device OE. This action can, for example, include sending a command message to the first communication module M1 ordering it to send to network R, via the interface device IN, a message signaling the temporary stop of the operation of the electronic device OE. For example, in the embodiment of commanding a door lock during a restart, it can include stopping the actuation of this lock by signaling it on the network R, in such manner that this command is emitted again at the soonest, once the voltage drop of the supply network BA comes to an end.

Another suspend action can include generating a command to cause an immediate reduction of the electrical consumption of the control device MC in operation of their type, as previously indicated as an example.

Another suspend action can include in generating a command to cause a stop of the operation of the control device MC, in order to cause a correct stop of the operation of the electronic device OE.

To be noted, one or several of the aforementioned actions or even all of them can be executed, in the order used to describe them. The previously described actions are only illustrative examples. The proposed list of actions is therefore non-limiting, and other types of actions can be envisioned.

To be noted also, in the illustrated non-limiting embodiment, the management device MG is part of the control device MC, but, this is not required. They can indeed be external to the control device MC and be connected to the latter MC. In this way, it can be envisioned that the device D includes a housing accommodating the management device MG and the auxiliary supply device MA, which is housed in the electronic device OE or connected to the latter (OE).

Therefore, the management device MG can be created in the form of electronic circuits, logic or software modules, or in a combination of electronic circuits and logic modules.

To be noted also, although this is not illustrated in the unique figure, the device D can eventually include voltage value, for example zero, pull-up device installed in the electrical link which connects the output S1 of the interface device IN to the management device MG. These voltage value pull-up device format the stop signal to make it exploitable by the management device MG. Indeed, when the voltage supply device CV is constrained to stop operation, in particular following the reception of a stop signal, this can induce high impedance which necessitates pull-up at a selected voltage value. As a non-limiting example, the voltage value pull-up device can appear in the form of a pull-up resistor to the ground, in other words, imposing a zero voltage in embodiment of high impedance on the output S1.

Since the invention allows in particular for prolonging during a predefined time the operation of the control device MC of an electronic device OE, it therefore allows for performing local actions, on the one side, ensuring a stop of this electronic device OE in a logic state which will allow for correct rebooting and to reassume its logic state before the voltage drop, and eventually on the other hand, to warn the other electronic devices of the network which are affected by this operation stop. Consequently, the present invention improves at low cost the operation, the performance and the interoperability of the electronic devices of a communication network during the restart phases.

The present invention is not limited to the implementation modes of the control device and the communicating electronic device described above, only as examples, but it encompasses all variants that a person skilled in the art will be able to envision within the scope of the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A controller for an electronic device for connection to a communication network, comprising:
a voltage supply device for reception of a voltage from an electrical supply source;
a control device for reception of said voltage from said voltage supply device and at least managing a communication protocol of said network; and
an interface device for reception of said voltage from said voltage supply device and securement of the interface between said control device and said communication network, said interface device including a auxiliary supply device configured to supply to said control device an auxiliary voltage greater than a first selected threshold during a predefined time following an exclusion of the operation of said voltage supply device requested by a stop signal when the voltage of said electrical supply network or the voltage supplied by said voltage supply device is lower than a second selected threshold; and
a management device connected to said output of the interface device and configured for reception of said stop signal for execution during said predefined time at least one suspend action in view of restarting in good conditions of a part of at least of said electronic device.

16. The controller according to claim 15, wherein each suspend action is selected from a group, comprising:
at least the generation of a command to stop the operation of said interface device; the generation of a command to stop the operation of at least one external electrical device controlled by said control device in operation of eventual constraints;
the generation of a command to cause the storage of information; the generation of a command to cause the generation of protocol commands to improve the restart of a communication in progress with the network;
the generation of a command to cause the generation of a signal intended to warn said network of the temporary stop of the operation of said electronic device;
the generation of a command to cause the reduction of the electrical consumption of said control device in operation of their type;
the generation of a command to cause the reduction of the electrical consumption of at least one electrical device controlled by said control device; and
the generation of a command to stop the operation of said control device to cause a stop of the operation of said electronic device.

17. The controller according to claim 15, wherein said interface device is configured for delivery of said stop signal to an output when said voltage of said electrical supply network is lower than a first selected threshold; and
said management device is connected to said output of said interface device for reception of said stop signals.

18. The controller according to claim 15, wherein said interface device is configured for delivery of said stop signal to an output when said voltage supplied by said voltage supply device is lower than a first selected threshold, and
said management device is connected to said output of the interface device for reception of said stop signals.

19. The controller according to claim 15, wherein auxiliary supply device inserts between a supply output of said voltage supply device and a supply input of said control device; and
the auxiliary supply device being configured for formation of a reserve of electrical energy starting from said electrical energy supplied by said voltage supply device when said voltage delivered by the latter is greater than a third selected threshold.

20. The controller according to claim 19, wherein said auxiliary supply device includes a capacitor suitable to discharge and deliver a decreasing auxiliary voltage that is greater than said second selected threshold during at least said predefined time.

21. The controller according to claim 20, wherein said capacitor is a polarized type.

22. The controller according to one of claim 15, further comprising:
a voltage value pull-up device installed on the electrical link connecting said output of said interface device to said management device and configured for support of a high impedance during the suspension of said operation of said voltage supply device.

23. The controller according to claim 15, wherein said management device is installed in said control device.

24. An electronic device for connection to a communication network, comprising:
a voltage supply device for reception of a voltage from a supply network;
a control device configured for reception of said voltage from said voltage supply device and for management of a communication protocol of said network; and
an interface device for reception of the voltage from said voltage supply device and securement of the interface between said control device and said communication network, said interface device including a control device.

25. The electronic device according to claim 24, wherein said voltage supply device is a DC/DC type conversion device for connection to an external electrical supply source.

26. The electronic device according to claim 24, wherein said interface device is an emitter receiver line.

27. The electronic device according to claim 24, wherein said control device is a microprocessor.

28. The controller according to claim 15, wherein said control device is adapted for use with said communication network in a vehicle.

29. The electronic device according to claim 24, wherein said control device is adapted for use with said communication network in a vehicle.
